(19) United States
(12) Patent Application Publication
(10) Pub. No.: US 2009/0191404 A1
(43) Pub. Date: Jul. 30, 2009

(54) Curable liquid composition, cured film, and antistatic laminate

(75) Inventors: Shingo Itai, Tokyo (JP); Yoshikazu Yamaguchi, Tokyo (JP); Zen Komiya, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignees: DSM IP Assets B.V., Te Heelen (NL); JSR Corporation, Tokyo (JP)

(21) Appl. No.: 10/592,767

(22) PCT Filed: Mar. 15, 2005
(86) PCT No.: PCT/NL2005/000197

§ 371 Date: Sep. 14, 2006

(30) Foreign Application Priority Data
Mar. 17, 2004 (JP) 2004 077247

(51) Int. Cl. B32B 27/32; C08F 2/44; C08K 3/22; C08F 2/46

(52) U.S. Cl. 428/336; 524/784; 522/81; 428/521; 524/783; 524/780

(57) ABSTRACT

The object of the invention is to provide a curate liquid composition excelling in storage stability and curability and capable of forming a coat (film) which excels in antistatic properties, hardness, scratch resistance, and transparency on the surface of various substrates, a cured film of the composition, and an anti static laminate. This object is achieved by providing a curate liquid composition comprising the following components (A), (B), (C), and (D): (A) particles comprising an oxide of at least one element selected from the group consisting of indium, antimony, zinc, and tin as a major component, (B) a compound having two or more polymerizable unsaturated groups in the molecule, (C) a silicon-containing surfactant, and (D) a solvent.

### TECHNICAL FIELD

The present invention relates to a curable liquid composition, a cured film, and an antistatic laminate. More particularly, the present invention relates to a curable liquid composition excelling in curability and capable of forming a coat (film) which excels in antistatic properties, hardness, scratch resistance, and transparency on various substrates such as plastics (polycarbonate, polymethylmethacrylate, polystyrene, polyester, polyolefin, epoxy resin, melamine resin, triacetylcellulose resin, ABS resin, AS resin, norbornene resin, etc.), metals, wood, paper, glass, ceramics, and slates. The present invention also relates to a cured film of the composition and an antistatic laminate.

### PRIOR ART

In order to ensure performance and safety in information communication equipment, a coat having scratch resistance and adhesion (hard coat) or a coat having antistatic properties (antistatic film) has been formed on the surface of the equipment by using a radiation curable composition.

An antireflection film having a multi-layer structure consisting of a low-refractive-index layer and a high-refractive-index layer is formed on the surface of an optical article in order to provide an antireflection function to the optical article.

In recent years, information communication equipment has been developed remarkably and been used in a wide range of application fields. Therefore, further improvement of performance and productivity of the hard coat, antistatic film, antireflection film, and the like has been demanded.

In the field of optical articles such as plastic lenses, there has been a demand for prevention of adhesion of dust due to static electricity and a decrease in transmittance due to reflection. In the field of display panels, there has been a demand for prevention of adhesion of dust due to static electricity and reflection of light on the screen.

To deal with these demands, various radiation curable materials have been proposed because of their high productivity and curability at room temperature.

For example, a composition containing a sulfonic acid monomer and a phosphoric acid monomer as ionic conductive components (Japanese Patent Application Laid-open No. 47-34539); a composition containing chain-like metal powder (Japanese Patent Application Laid-open No. 55-78070); a composition containing tin oxide particles, a polyfunctional acrylate, and a copolymer of methylmethacrylate and a polyether acrylate as major components (Japanese Patent Application Laid-open No. 60-60166); a conductive paint composition containing a pigment coated with a conductive polymer (Japanese Patent Application Laid-open No. 2-194071); an optical disk material containing a trifunctional acrylate, a compound having a monofunctional ethylenically unsaturated group, a photoinitiator, and conductive powder (Japanese Patent Application Laid-open No. 4-172634); a conductive paint containing a hydrolysate of antimony-doped tin oxide particles dispersed by using a silane coupling agent and a tetraalkoxysilane, a photosensitizer, and an organic solvent (Japanese Patent Application Laid-open No. 6-264009); a conductive coating agent containing a conductive filler, a UV curable resin, and a silicon-containing leveling agent (Japanese Patent Application Laid-open No. 7-196956); a curable liquid resin composition containing a reaction product of an alkoxysilane having a polymerizable unsaturated group in the molecule with metal oxide particles, a trifunctional acrylic compound, and a radiation polymerization initiator (Japanese Patent Application Laid-open No. 2000-143924); a paint for forming a transparent conductive film containing conductive oxide micropowder having a primary particle diameter of 100 nm or less, a low-boiling-point solvent which readily allows the conductive oxide micropowder to be dispersed therein, a low-boiling-point solvent which scarcely allows the conductive oxide micropowder to be dispersed therein, and a binder resin (Japanese Patent Application Laid-open No. 2001-131485); and the like have been proposed.

### PROBLEMS TO BE SOLVED BY THE INVENTION

The above conventional technologies are effective to a certain extent. However, the conventional technologies are not satisfactory in order to produce a cured film which must have all the functions as a hard coat, an antistatic film, and an antireflection film.

For example, the conventional technologies as disclosed in the above Patent Documents have the following problems. The composition disclosed in Japanese Patent Application Laid-open No. 47-34539, which contains an ion-conductive substance, has insufficient antistatic properties. The antistatic properties of this composition change during drying. The composition disclosed in Japanese Patent Application Laid-open No. 55-78070 has insufficient transparency, since chain-like metal powder having a large particle diameter is dispersed in the composition. Since the composition disclosed in Japanese Patent Application Laid-open No. 60-60166 contains a large amount of an uncurable dispersing agent, the resulting cured film has insufficient hardness. Since the material disclosed in Japanese Patent Application Laid-open No. 4-172634 contains a high concentration of static inorganic particles, transparency is poor. The paint disclosed in Japanese Patent Application Laid-open No. 6-264009 has insufficient long-term storage stability. Japanese Patent Application Laid-open No. 7-196956 does not disclose a resin component containing a monomer with three or more functional groups. Japanese Patent Application Laid-open No. 2000-143924 does not disclose a process for producing a composition having antistatic properties. In the case of forming a transparent conductive film by applying and drying the paint disclosed in Japanese Patent Application Laid-open No. 2001-131485, since the organic matrix consisting of the binder does not have a crosslinked structure, resistance to an organic solvent is insufficient.

A person skilled in the art could have easily arrived at the conclusion that the antistatic properties are improved by increasing the amount of conductive particles. However, an increase in the amount of conductive particles results in a decrease in transparency due to an increase in absorption of visible rays in the resulting cured film. Moreover, curability is decreased due to a decrease in ultraviolet transmissibility. Furthermore, adhesion to a substrate and leveling properties of a coating liquid are impaired. If the amount of conductive particles is decreased, sufficient antistatic properties cannot be obtained.

The present invention has been achieved in view of the above problems. An object of the present invention is to provide a curable liquid composition excelling in curability and capable of forming a coat (film) which excels in antistatic properties, hardness, scratch resistance, and transparency on the surface of various substrates, a cured film of the composition, and an antistatic laminate. A particular object of the present invention is to provide a curable liquid composition, a cured film, and an antistatic laminate capable of providing excellent antistatic properties by using a small amount of oxide particles.

### MEANS FOR SOLVING THE PROBLEMS

As a result of extensive studies, the present inventors have found that the above object can be achieved by a composition comprising specific components. This finding has led to the completion of the present invention.

Specifically, the present invention provides the following curable liquid composition, cured film, and antistatic laminate.
[1] A curable liquid composition comprising the following components (A), (B), (C), and (D):
   (A) particles comprising an oxide of at least one element selected from the group consisting of indium, antimony, zinc, and tin as a major component,
   (B) a compound having two or more polymerizable unsaturated groups in the molecule,
   (C) a silicon-containing surfactant, and
   (D) a solvent.
[2] The curable liquid composition described in [1], comprising (E) a photoinitiator in addition to the components (A) to (D).
[3] The curable liquid composition described in [1] or [2], wherein the component (A) is particles including either antimony-doped tin oxide (ATO) or tin-doped indium oxide (ITO) as a major component.
[4] The curable liquid composition described in any one of [1] to [3], wherein the component (A) is oxide particles surface-treated by a surface treatment agent.
[5] The curable liquid composition described in [4], wherein the surface treatment agent is a compound including at least two polymerizable unsaturated groups, a group shown by the following formula (1),

—X—C(═Y)—NH— (1)

wherein X represents NH, O (oxygen atom), or S (sulfur atom), and Y represents O or S, and a silanol group or a group which forms a silanol group by hydrolysis.
[6] The curable liquid composition described in [5], wherein the group shown by the formula (1) is at least one group selected from the group consisting of —O—C(═O)—NH—, —O—C(═S)—NH—, and —S—C(═O)—NH—.
[7] The curable liquid composition described in any one of [1] to [6], wherein the content of the component (A) in the composition is 10 wt % or less of the total amount of the composition except for the component (D).
[8] A cured film obtained by curing the curable liquid composition according to any one of [1] to [7] having a surface resistivity of 1×10¹² ohm/square or less.
[9] A process for producing a cured film, comprising a step of curing the curable liquid composition described in any of [1] to [7] by applying radiation to the composition.
[10] An antistatic laminate comprising a layer of a cured film produced by curing the curable liquid composition described in any one of [1] to [7].
[11] The antistatic laminate described in [10], wherein the thickness of the layer of the cured film is 0.1-20 μm.

### EFFECT OF THE INVENTION

The present invention can provide a curable liquid composition excelling in storage stability and curability and capable of forming a coat (film) which excels in antistatic properties, hardness, scratch resistance, and transparency on the surface of various substrates, a cured film of the composition, and an antistatic laminate. In addition, the present invention can provide a curable liquid composition, a cured film, and an antistatic laminate capable of providing excellent antistatic properties by using a small amount of oxide particles.

### BEST MODE FOR CARRYING OUT THE PRESENT INVENTION

The present invention will now be described in detail by way of embodiments.

### I. Curable Liquid Composition

The curable liquid composition of the present invention comprises (A) particles including an oxide of at least one element selected from the group consisting of indium, antimony, zinc, and tin as a major component, (B) a compound having at least two polymerizable unsaturated groups in the molecule, (C) a silicone-based surfactant, and (D) a solvent.

Each component is described below in more detail.

### 1. Component (A)

The component (A) used in the present invention is particles containing, as a major component, an oxide of at least one element selected from the group consisting of indium, antimony, zinc, and tin from the viewpoint of securing conductivity and transparency of the cured film of the curable liquid composition. These oxide particles are conductive particles.

As specific examples of the oxide particles used as the component (A), at least one type of particles selected from the group consisting of tin-doped indium oxide (ITO), antimony-doped tin oxide (ATO), fluorine-doped tin oxide (FTO), phosphorus-doped tin oxide (PTO), zinc antimonate (AZO), indium-doped zinc oxide (IZO), and zinc oxide can be given. Of these, antimony-doped tin oxide (ATO) and tin-doped indium oxide (ITO) are preferable. These particles may be used either individually or in combination of at least two.

As examples of commercially available products of these oxide particles, T-1 (ITO) (manufactured by Mitsubishi Materials Corporation), Passtran (ITO, ATO) (manufactured by Mitsui Mining & Smelting Co., Ltd.), SN-100P (ATO) (manufactured by Ishihara Sangyo Kaisha, Ltd.), NanoTek ITO (manufactured by C.I. Kasei Co., Ltd.), ATO, FTO (manufactured by Nissan Chemical Industries, Ltd.), and the like can be given.

The oxide particles used as the component (A) may be used in a powder state or a dispersion state in a solvent. It is preferable to use the oxide particles in a dispersion state in a solvent, since uniform dispersibility can be easily obtained.

As examples of commercially available products in which oxide particles used as the component (A) are dispersed in a solvent, MTC Filler 12867 (aqueous dispersion of ATO), MHI Filler #8954MS (methyl ethyl ketone dispersion of ATO) (manufactured by Mikuni Color, Ltd.), SN-100D (aqueous dispersion of ATO), SNS-101 (isopropyl alcohol dispersion of ATO), SNS-10B (isobutanol dispersion of ATO), SNS-10M (methyl ethyl ketone dispersion of ATO), FSS-10M (isopropyl alcohol dispersion of ATO) (manufactured by Ishihara Sangyo Kaisha, Ltd.), Celnax CX-Z401M (methanol dispersion of zinc antimonate), Celnax CX-Z2001P (isopropyl alcohol dispersion of zinc antimonate) (manufactured by Nissan Chemical Industries, Ltd.), aqueous dispersion, methanol dispersion, isopropyl alcohol dispersion, methyl ethyl ketone dispersion, and toluene dispersion of Passtran type-A (ITO) (Mitsui Mining and Smelting Co., Ltd.), and the like can be given.

The oxide particles used as the component (A) may be oxide particles surface-treated by using a surface treatment agent in order to improve dispersibility in a solvent.

As examples of a surface treatment agent, alkoxysilane compounds, tetrabutoxytitanium, tetrabutoxyzirconium, tetraisopropoxyaluminum, and the like can be given. The solvent may be used either individually or in combination of at least two.

As specific examples of alkoxysilane compounds, compounds having an unsaturated double bond in the molecule such as γ-methacryloxypropyltrimethoxysilane, γ-acryloxypropyltrimethoxysilane, and vinyltrimethoxysilane; compounds having an epoxy group in the molecule such as γ-glycidoxypropyltriethoxysilane and γ-glycidoxypropyltrimethoxysilane; compounds having an amino group in the molecule such as γ-aminopropyltriethoxysilane and γ-aminopropyltrimethoxysilane; compounds having a mercapto group in the molecule such as γ-mercaptopropyltrimethoxysilane and γ-mercaptopropyltriethoxysilane; alkylsilanes such as methyltrimethoxysilane, methyltriethoxysilane, and phenyltrimethoxysilane; and the like can be given. Of these, γ-mercaptopropyltrimethoxysilane, γ-glycidoxypropyltrimethoxysilane, methyltrimethoxysilane, methyltriethoxysilane, and phenyltrimethoxysilane are preferable from the viewpoint of dispersion stability of the surface-treated oxide particles.

As examples of commercially available products of surface-treated oxide particle powder, SN-102P (ATO) and FS-12P (manufactured by Ishihara Sangyo Kaisha, Ltd.), and the like can be given.

As the surface treatment agent, a compound including a functional group which copolymerizes or cross-links with an organic resin (reactive surface treatment agent) is also preferable. As such a surface treatment agent, the above compound including an unsaturated double bond in the molecule, or a compound including at least two polymerizable unsaturated groups, a group shown by the following formula (1),

—X—C(═Y)—NH— (1)

wherein X represents NH, O (oxygen atom), or S (sulfur atom), and Y represents O or S, and a silanol group or a group which forms a silanol group by hydrolysis.

The group shown by the formula (1) is preferably at least one group selected from the group consisting of a urethane bond [—O—C(═O)—NH—], —O—C(═S)—NH—, and a thiourethane bond [—S—C(═O)—NH—].

As examples of such a surface treatment agent, an alkoxysilane compound comprising a urethane bond [—O—C(═O)NH—] and/or a thiourethane bond [—S—C(═O)NH—] and at least two polymerizable unsaturated groups in the molecule can be given. As a specific example of such a compound, a compound shown by the following formula (2) can be given.

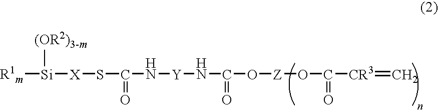

wherein R¹ represents a methyl group, R² represents an alkyl group having 1-6 carbon atoms, R³ represents a hydrogen atom or a methyl group, m represents an integer of either 1 or 2, n represents an integer of 1-5, X represents a divalent alkylene group having 1-6 carbon atoms, Y represents a linear, cyclic, or branched divalent hydrocarbon group having 3-14 carbon atoms, Z represents a linear, cyclic, or branched divalent hydrocarbon group having 2-14 carbon atoms. Z may include an ether bond.

The compound shown by the formula (2) may be prepared by reacting a mercaptoalkoxysilane, a diisocyanate, and a hydroxyl group-containing polyfunctional (meth)acrylate.

As a preferable preparation method, a method of reacting a mercaptoalkoxysilane with a diisocyanate to obtain an intermediate containing a thiourethane bond, and reacting the residual isocyanate with a hydroxyl group-containing polyfunctional (meth)acrylate to obtain a product containing a urethane bond can be given.

The same product may be obtained by reacting a diisocyanate with a hydroxyl group-containing polyfunctional (meth)acrylate to obtain an intermediate containing a urethane bond, and reacting the residual isocyanate with a mercaptoalkoxysilane. However, since this method causes the addition reaction of the mercaptoalkoxysilane and the (meth)acrylic group to occur, purity of the product is decreased. Moreover, a gel may be formed.

As examples of the mercaptoalkoxysilane used to produce the compound shown by the formula (2), γ-mercaptopropyltrimethoxysilane, 7-mercaptopropyltriethoxysilane, γ-mercaptopropyltributoxysilane, γ-mercaptopropyldimethylmethoxysilane, γ-mercaptopropylmethyldimethoxysilane, and the like can be given. Of these, γ-mercaptopropyltrimethoxysilane and γ-mercaptopropylmethyldimethoxysilane are preferable.

As examples of commercially available products of the mercaptoalkoxysilane, SH6062 (manufactured by Toray-Dow Corning Silicone Co., Ltd.) can be given.

As examples of diisocyanates, 1,4-butylene diisocyanate, 1,6-hexylene diisocyanate, isophorone diisocyanate, hydrogenated xylylene diisocyanate, hydrogenated bisphenol A diisocyanate, 2,4-toluene diisocyanate, 2,6-toluene diisocyanate, and the like can be given. Of these, 2,4-toluene diisocyanate, isophorone diisocyanate, and hydrogenated xylylene diisocyanate are preferable.

As examples of commercially available products of the polyisocyanate compounds, TDI-80/20, TDI-100, MDI-CR100, MDI-CR300, MDI-PH, NDI (manufactured by Mitsui Nisso Urethane Co., Ltd.), Coronate T, Millionate MT, Millionate MR, HDI (manufactured by Nippon Polyurethane Industry Co., Ltd.), Takenate 600 (manufactured by Takeda Chemical Industries, Ltd.), and the like can be given.

As examples of hydroxyl group-containing polyfunctional (meth)acrylates, trimethylolpropane di(meth)acrylate, tris(2-hydroxyethyl)isocyanurate di(meth)acrylate, pentaerythritol tri(meth)acrylate, dipentaerythritol penta(meth)acrylate, and the like can be given. Of these, tris(2-hydroxyethyl)isocyanurate di(meth)acrylate, pentaerythritol tri(meth)acrylate, and dipentaerythritol penta(meth)acrylate are preferable. These compounds form at least two polymerizable unsaturated groups in the compound shown by the formula (2).

The mercaptoalkoxysilane, diisocyanate, and hydroxyl group-containing polyfunctional (meth)acrylate may be used either individually or in combination of at least two.

In the preparation of the compound shown by the formula (2), the mercaptoalkoxysilane, diisocyanate, and hydroxyl group-containing polyfunctional (meth)acrylate are used so that the molar ratio of the diisocyanate to the mercaptoalkoxysilane is preferably 0.8-1.5, and still more preferably 1.0-1.2. If the molar ratio is less than 0.8, storage stability of the composition may be decreased. If the molar ratio exceeds 1.5, dispersibility may be decreased.

The molar ratio of the hydroxyl group-containing (meth)acrylate to the diisocyanate is preferably 1.0-1.5, and still more preferably 1.0-1.2. If the molar ratio is less than 1.0, the composition may gel. If the molar ratio exceeds 1.5, antistatic properties may be decreased.

It is preferable to prepare the compound shown by the formula (2) in dry air in order to prevent anaerobic polymerization of the acrylic group and hydrolysis of the alkoxysilane. The reaction temperature is preferably 0-100° C., and still more preferably 20-80° C.

In the preparation of the compound shown by the formula (2), a conventional catalyst may be used in the urethanization reaction in order to reduce the preparation time. As the catalyst, dibutyltin dilaurate, dioctyltin dilaurate, dibutyltin di(2-ethylhexanoate), and octyltin triacetate can be given. The catalyst is added in an amount of 0.01-1 wt % for the total amount of the catalyst and the diisocyanate.

A heat polymerization inhibitor may be added in the preparation in order to prevent heat polymerization of the compound shown by the formula (2). As examples of heat polymerization inhibitors, p-methoxyphenol, hydroquinone, and the like can be given. The heat polymerization inhibitor is added in an amount of preferably 0.01-1 wt % for the total amount of the heat polymerization inhibitor and the hydroxyl group-containing polyfunctional (meth)acrylate.

The compound shown by the formula (2) may be prepared in a solvent. As the solvent, any solvent which does not react with mercaptoalkoxysilane, diisocyanate, and hydroxyl group-containing polyfunctional (meth)acrylate, and has a boiling point of 200° C. or less may be appropriately selected.

As specific examples of such a solvent, ketones such as methyl ethyl ketone, methyl isobutyl ketone, and cyclohexanone, esters such as ethyl acetate, butyl acetate, and amyl acetate, hydrocarbons such as toluene and xylene, and the like can be given.

In the present invention, the surface-treated oxide particles may be prepared by subjecting the surface treatment agent to hydrolysis in the presence of the oxide particles (A). It is preferable to use a method of adding water to a mixture of the oxide particles (A), surface treatment agent, and organic solvent, and subjecting the mixture to hydrolysis.

In this preparation method, it is presumed that the alkoxy group is converted to a silanol group (Si—OH) by hydrolysis of the surface treatment agent, and the silanol group reacts with a metal hydroxide (M-OH) on the oxide particles to form a metaloxane bond (M—O—Si), whereby the surface treatment agent adheres to the particles.

The surface treatment agent is added in an amount of preferably 0.1-50 parts by weight, and still more preferably 1-35 parts by weight for 100 parts by weight of the oxide particles (A). If the amount of the surface treatment agent is less than 0.1 parts by weight, abrasion resistance of the resulting cured film may be insufficient. If the amount of the surface treatment agent exceeds 50 parts by weight, antistatic properties may be insufficient.

Water is added in an amount of preferably 0.5-1.5 equivalents for the total alkoxy equivalent in the surface treatment agent. Water is added in an amount of preferably 0.5-5.0 parts by weight for 100 parts by weight of the surface treatment agent. Ion-exchanged water or distilled water is preferably used as the water.

Hydrolysis may be carried out by heating the mixture with stirring at a temperature between 0° C. and the boiling point of the components (usually 30-100° C.) for 1-24 hours in the presence of an organic solvent. The organic solvent may not be added in the case of using the oxide particles (A) which are dispersed in an organic solvent. In this case, an organic solvent may optionally be added.

An acid or a base may be added as a catalyst in order to accelerate the reaction during hydrolysis.

As examples of acids, inorganic acids such as hydrochloric acid, nitric acid, sulfuric acid, and phosphoric acid, organic acids such as methanesulfonic acid, toluenesulfonic acid, phthalic acid, malic add, tartaric acid, malonic acid, formic acid, oxalic acid, methacrylic acid, acrylic acid, and itaconic acid, ammonium salts such as tetramethylammonium hydrochloride and tetrabutylammonium hydrochloride, and the like can be given.

As examples of bases, aqueous ammonia, amines such as triethylamine, tributylamine, and triethanolamine, and the like can be given. It is preferable to use the acid as a catalyst. An organic acid is particularly preferable as a catalyst. The catalyst is added in an amount of preferably 0.001-1 part by weight, and still more preferably 0.01-0.1 part by weight for 100 parts by weight of the alkoxysilane compound.

The hydrolyzate of the surface treatment agent can be caused to effectively adhere to the oxide particles (A) by adding a dehydrating agent at the completion of hydrolysis.

As examples of dehydrating agents, organic carboxylic orthoesters and ketals can be given. Specific examples include methyl orthoformate, ethyl orthoformate, methyl orthoacetate, ethyl orthoacetate, acetone dimethylketal, diethyl ketone dimethylketal, acetophenone dimethylketal, cyclohexanone dimethylketal, cyclohexanone diethylketal, benzophenone dimethylketal, and the like can be given. Of these, organic carboxylic orthoesters are preferable. Methyl orthoformate and ethyl orthoformate are more preferable.

The dehydrating agent is added in an amount from equimolar to 10-fold molar excess, and preferably from equimolar to 3-fold molar excess of the water content in the composition. If the amount of the dehydrating agent is less than equimolar, improvement of storage stability may be insufficient. The dehydrating agent is preferably added after the preparation of the composition. This improves storage stability of the composition and accelerates formation of a chemical bond between the silanol group in the hydrolyzate of the surface treatment agent and the oxide particles (A).

The oxide particles (A) surface-treated by the surface treatment agent have remarkably superior dispersibility in a solvent. Therefore, it is presumed that the surface treatment agent adheres to the surface of the oxide particles (A) by a chemical bond through a siloxy group (Si—O—).

In the present invention, the oxide particles (A) surface-treated by using the reactive surface treatment agent are referred to as reactive particles (RA).

In the case where the shape of the component (A) is spherical, the primary particle diameter of the component (A) is 0.1 μm or less, and preferably 0.01-0.05 μm as a value determined by measuring the dried powder using a BET absorption method irrespective of whether or not the oxide particles are surface-treated. If the primary particle diameter of the component (A) exceeds 0.1 μm, precipitation may occur in the composition, or flatness and smoothness of the resulting film may be decreased. In the case where the shape of the component (A) is long and narrow such as needle-shaped, the minor axis number average particle diameter is preferably 0.005-0.1 μm and the major axis number average particle diameter is preferably 0.1-3 μm as the number average particle diameters determined by observing the dried powder using an electron microscope. If the major axis particle diameter of the component (A) exceeds 3 μm, precipitation may occur in the composition.

There are no specific limitations to the amount of the component (A) to be added. The amount of the component (A) is preferably 5-50 wt %, and still more preferably 5-30 wt % for 100 wt % of the total amount of the components in the α-composition, excluding the component (D). This also applies to the case where the component (A) is surface-treated. If the amount of the component (A) is less than 5 wt %, antistatic properties may be insufficient. If the amount of the component (A) exceeds 50 wt %, film formability may be insufficient.

In the present invention, the antistatic properties may be obtained even if the amount of the component (A) is 10 wt % or less.

### 2. Component (B)

The component (B) used in the present invention is a compound having at least two polymerizable unsaturated groups in the molecule from the viewpoint of film formability and transparency of the cured film of the curable liquid composition. A cured product having excellent scratch resistance and organic solvent resistance can be obtained by using the component (B). Preferably, B is an organic compound.

As specific examples of the component (B), a (meth)acrylate and a vinyl compound can be given.

As examples of (meth)acrylates, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, glycerol tri(meth)acrylate, tris(2-hydroxyethyl)isocyanurate tri(meth)acrylate, ethylene glycol di(meth)acrylate, 1,3-butanediol di(meth)acrylate, 1,4-butanediol di(meth)acrylate, 1,6-hexanediol di(meth)acrylate, neopentyl glycol di(meth)acrylate, diethylene glycol di(meth)acrylate, triethylene glycol di(meth)acrylate, dipropylene glycol di(meth)acrylate, bis(2-hydroxyethyl)isocyanurate di(meth)acrylate, tricyclodecanediyldimethanol di(meth)acrylate, poly(meth)acrylates of ethylene oxide or propylene oxide addition product of a starting alcohol used to produce these compounds, oligoester (meth)acrylates having at least two (meth)acryloyl groups in the molecule, oligoether (meth)acrylates, oligourethane (meth)acrylates, oligoepoxy (meth)acrylates, and the like can be given.

As examples of the vinyl compounds, divinylbenzene, ethylene glycol divinyl ether, diethylene glycol divinyl ether, and triethylene glycol divinyl ether can be given. Of these, dipentaerythritol hexa(meth)acrylate, dipentaerythritol penta(meth)acrylate, trimethylolpropane tri(meth)acrylate, pentaerythritol tri(meth)acrylate, pentaerythritol tetra(meth)acrylate, ditrimethylolpropane tetra(meth)acrylate, tris(2-hydroxyethyl)isocyanurate tri(meth)acrylate, bis(2-hydroxyethyl)isocyanurate di(meth)acrylate, and tricyclodecanediyldimethanol di(meth)acrylate are preferable. The component (B) may be used either individually or in combination of at least two.

A trifunctional and higher functional (meth)acrylate monomer can also be used as the component (B). Examples of such monomers include trifunctional (meth)acrylate monomers such as pentaerythrtol tri(meth)acrylate, trimethylolpropane tri(meth)acrylate, glycerol tri(meth)acrylate, tris(2-hydroxyethyl)isocyanurate tri(meth)acrylate, and tris(2-hydroxyethyl)isocyanurate tri(meth)acrylate, tetrafunctional (meth)acrylate monomers such as pentaerythritol tetra(meth)acrylate and ditrimethylolpropane tetra(meth)acrylate, pentafunctional (meth)acrylate monomers such as dipentaerythritol penta(meth)acrylate, and hexafunctional (meth)acrylate monomers such as dipentaerythritol hexa(meth)acrylate.

The amount of the component (B) in the composition is preferably 50-94 wt %, and still more preferably 55-94 wt % for 100 wt % of the total amount of the components in the composition excluding the component (D). If the amount of the component (B) is less than 50 wt %, transparency of the resulting cured product may be insufficient. If the amount of the component (B) exceeds 94 wt %, antistatic properties may be insufficient.

### 3. Component (C)

The component (C) used in the present invention is a silicone-based surfactant. A cured product having excellent transparency can be obtained by using the component (C).

Polydimethylsiloxane and the like can be given as specific examples of compound (C).

As examples of commercially available products of the component (C), SURFYNOL DF-58 (manufactured by Nisshin Chemical Industry Co., Ltd.), ADDID 160, 700, 720, and 810 (manufactured by Wacker Chemical Corporation), and the like can be given.

The amount of the component (C) in the composition is preferably 0.01-5 wt %, and still more preferably 0.01-1 wt % for 100 wt % of the total amount of the components in the composition excluding the component (D). If the amount of the component (C) is less than 0.01 wt %, transparency of the resulting cured product may be insufficient. If the amount of the component (C) exceeds 5 wt %, antistatic properties may be insufficient.

### 4. Component (D)

The solvent (D) is added in an amount to make the total concentration of the components in the composition other than the component (D) 0.5-75 wt %. Specifically, the total amount of the solvent to be added is preferably 33.3-19,900 parts by weight for 100 parts by weight of the total amount of the components other than the component (D). If the amount of the solvent is less than 33.3 parts by weight, the viscosity of the composition may increase, whereby applicability may decrease. If the total amount of the solvent exceeds 19,900 parts by weight, the thickness of the resulting cured product may excessively decrease, whereby sufficient hardness may not be obtained.

There are no specific limitations to the solvent. It is preferable to use a solvent having a boiling point of 200° C. or less at atmospheric pressure. As specific examples of the solvent, water, alcohol, ketone, ether, ester, hydrocarbon, amide, and the like can be given. The solvent may be used either individually or in combination of at least two.

As examples of alcohols, methanol, ethanol, isopropyl alcohol, isobutanol, n-butanol, tert-butanol, ethoxyethanol, butoxyethanol, diethylene glycol monoethyl ether, benzyl alcohol, phenethyl alcohol, and the like can be given. As examples of ketones, acetone, methyl ethyl ketone, methyl isobutyl ketone, cyclohexanone, and the like can be given. As examples of ethers, dibutyl ether, propylene glycol monoethyl ether acetate, and the like can be given. As examples of esters, ethyl acetate, butyl acetate, ethyl lactate, methyl acetoacetoate, ethyl acetoacetate, and the like can be given. As examples of hydrocarbons, xylene and the like can be given. As examples of amides, N,N-dimethylformamide, N,N-dimethylacetamide, N-methylpyrrolidone, and the like can be given.

### 5. Component (E)

The curable liquid composition of the present invention is cured by merely applying radiation. In order to further increase the cure speed, a photoinitiator may be added as the component (E).

In the present invention, radiation refers to visible rays, ultraviolet rays, deep ultraviolet rays, X-rays, electron beams, α-rays, β-rays, γ-rays, and the like.

The amount of the component (E) in the composition is preferably 0.1-15 wt %, and still more preferably 0.5-10 wt % for 100 wt % of the total amount of the components in the composition excluding the component (D). The component (E) may be used either individually or in combination of at least two.

As examples of the component (E), 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michier's ketone, benzoin propyl ether, benzoin ethyl ether, benzyl dimethyl ketal, 1-(4-isopropylphenyl)-2-hydroxy-2-methylpropan-1-one, 2-hydroxy-2-methyl-1-phenylpropan-1-one, thioxanethone, diethylthioxanthone, 2-isopropylthioxanthone, 2-chlorothioxanthone, 2-methyl-1-[4-(methylthio)phenyl]-2-morpholino-propan-1-one, 2,4,6-trimethylbenzoyidiphenylphosphine oxide, bis-(2,6-dimethoxybenzoyl)-2,4,4-trimethylpentylphosphine oxide, and the like can be given.

### 6. Other Compounds Including a Polymerizable Unsaturated Group

As an additive other than the components (A) to (E), other compounds including a polymerizable unsaturated group (component (F)) may be added to the composition of the present invention, if necessary. The component (F) is a compound which includes one polymerizable unsaturated group in the molecule.

As specific examples of the component (F), vinyl group-containing lactams such as N-vinylpyrrolidone and N-vinylcaprolactam, (meth)acrylates having an alicyclic structure such as isobornyl (meth)acrylate, bornyl (meth)acrylate, tricyclodecanyl (meth)acrylate, dicyclopentanyl (meth)acrylate, dicyclopentenyl (meth)acrylate, and cyclohexyl (meth)acrylate; benzyl (meth)acrylate, 4-butylcyclohexyl (meth)acrylate, acryloylmorpholine, vinylimidazole, vinylpyridine, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, undecyl (meth)acrylate, dodecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl(meth)acrylate, phenoxyethyl(meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone(meth)acrylamide, isobutoxymethyl(meth)acrylamide, N,N-dimethyl(meth)acrylamide, t-octyl(meth)acrylamide, dimethylaminoethyl (meth)acrylate, diethylaminoethyl (meth)acrylate, 7-amino-3,7-dimethyloctyl (meth)acrylate, N,N-diethyl(meth)acrylamide, N,N-dimethylaminopropyl(meth)acrylamide, hydroxy butyl vinyl ether, lauryl vinyl ether, cetyl vinyl ether, 2-ethylhexyl vinyl ether, a compound shown by the following formula (3), and the like can be given.

CH₂—C(R⁴)—COO(R⁵⁰)ₚ-Ph-R⁶ (3)

wherein R⁴ represents a hydrogen atom or a methyl group, R⁵ represents an alkylene group having 2-6, and preferably 2-4 carbon atoms, R⁶ represents a hydrogen atom or an alkyl group having 1-12, and preferably 1-9 carbon atoms, Ph represents a phenylene group, and p is an integer of 0-12, and preferably 1-8.

As commercially available products of the component (F), Aronix M-101, M-102, M-111, M-113, M-114, M-117 (manufactured by Toagosei Co., Ltd.), Viscoat LA, STA, IBXA, 2-MTA, #192, #193 (manufactured by Osaka Organic Chemical Industry Co., Ltd.), NK EsterAMP-10G, AMP-20G, AMP-60G (manufactured by Shin-Nakamura Chemical Co., Ltd.), Light Acrylate L-A, S-A, IB-XA, PO-A, PO-200A, NP4EA, NP-8EA (manufactured by Kyoeisha Chemical Co., Ltd.), FA-511, FA-512A, FA-513A (manufactured by Hitachi Chemical Co., Ltd.), and the like can be given.

### 7. Additives

Antioxidants, UV absorbers, light stabilizers, heat polymerization inhibitors, leveling agents, surfactants, and lubricants may be added to the composition of the present invention as other additives. Examples of antioxidants include Irganox 1010, 1035, 1076, 1222 (manufactured by Ciba Specialty Chemicals Co., Ltd.), and the like. Examples of UV absorbers include Tinuvin P234, 320, 326, 327, 328, 213, 329 (manufactured by Ciba Specialty Chemicals Co., Ltd.), Seesorb 102, 103, 501, 202, 712, (manufactured by Shipro Kasei Kaisha, Ltd.), and the like. Examples of light stabilizers include Tinuvin 292, 144, 622LD (manufactured by Ciba Specialty Chemicals Co., Ltd.), Sanol LS770, LS440 (manufactured by Sankyo Co., Ltd.), Sumisorb TM-061 (manufactured by Sumitomo Chemical Co., Ltd.), and the like.

The viscosity of the composition of the present invention thus obtained at 25° C. is usually 1-20,000 mPa·s, and preferably 1-1,000 mPa·s.

### 8. Non-Conductive Particles

In the present invention, non-conductive particles or particles obtained by reacting non-conductive particles with an alkoxysilane compound in an organic solvent may be used in combination insofar as the curable liquid composition does not separate or gel.

Scratch resistance can be improved by using the non-conductive particles in combination with the oxide particles (component (A)) while maintaining the antistatic function, specifically, maintaining a surface resistivity of the resulting cured product at 10¹² ohm/square or less.

There are no specific limitations to the non-conductive particles insofar as the non-conductive particles are particles other than the oxide particles (component (A)). The non-conductive particles are preferably oxide particles other than the component (A) or metal-particles. As specific examples of the non-conductive particles, oxide particles such as silicon oxide, aluminum oxide, zirconium oxide, titanium oxide, and cerium oxide, or oxide particles including at least two elements selected from the group consisting of silicon, aluminum, zirconium, titanium, and cerium can be given.

The primary particle diameter of the non-conductive particles determined by measuring the dried powder using the BET adsorption method is preferably 0.1 μm or less, and still more preferably 0.001-0.05 μm. If the primary particle diameter exceeds 0.1 μm, precipitation may occur in the composition, or flatness and smoothness of the resulting film may decrease.

In the case of adding the non-conductive particles to the composition of the present invention, the non-conductive particles may be added after subjecting the non-conductive particles and the alkoxysilane compound to hydrolysis in an organic solvent. This hydrolysis step improves dispersion stability of the non-conductive particles. The hydrolysis of the non-conductive particles and the alkoxysilane compound in an organic solvent may be carried out in the same manner as the oxide particles (component (A)).

Commercially available products of the non-conductive particles are listed below. As examples of commercially available products of silicon oxide particles (silica particles, for example), as colloidal silica, Methanol Silica Sol, IPA-ST, MEK-ST, NBA-ST, XBA-ST, DMAC-ST, ST-UP, ST-OUP, ST-20, ST-40, ST-C, ST-N, ST-O, ST-50, ST-OL (manufactured by Nissan Chemical Industries, Ltd.), and the like can be given. As powdery silica, products available under the trade names AEROSIL 130, AEROSIL 300, AEROSIL 380, AEROSIL TT600, and AEROSIL OX50 (manufactured by Japan Aerosil Co., Ltd.), Sildex H31, H32, H51, H52, H121, H122 (manufactured by Asahi Glass Co., Ltd.), E220A, E220 (manufactured by Nippon Silica Industrial Co., Ltd.), SYLYSIA470 (manufactured by Fuji Silycia Chemical Co., Ltd.) and SG Flake (manufactured by Nippon Sheet Glass Co., Ltd.), and the like can be given.

As aqueous dispersion products of aluminum oxide (alumina), Alumina Sol-100, -200, -520 (manufactured by Nissan Chemical Industries, Ltd.) can be given. As aqueous dispersion products of zirconium oxide, toluene or methyl ethyl ketone dispersion zirconia sol (manufactured by Sumitomo Osaka Cement Co., Ltd.) can be given. As an aqueous dispersion liquid of cerium oxide, Needral (manufactured by Taki Chemical Co., Ltd.) can be given. As powder or solvent dispersion products of alumina, zirconium oxide, and titanium oxide, NanoTek (manufactured by C.I. Kasei Co., Ltd.) can be given.

The amount of the non-conductivity particles in the composition is preferably 0.1-70 wt %, more preferably 1-50 wt %, and particularly preferably 1-40 wt % for 100 wt % of the total amount of the components in the composition excluding the component (D).

In the cured film and the laminate of the present invention described below, effective conductivity can be realized by the addition of the component (A) in a smaller amount. Moreover, since the amount of the component (A) to be added can be reduced, a film in which absorption and scattering of light caused by the component (A) are small and which has higher transparency can be formed.

In a preferred embodiment, the composition according to the invention comprises 5-50 wt % A, 50-94 wt % B, 0.01-5 wt % C, all relative to the total composition excluding D, and D in an amount such that the total concentration of components other than (D) in the composition is between 0, 5-75 wt %. In a more preferred embodiment, the preferred composition also comprises 0, 1-15 wt % E.

### II. Cured Film and Antistatic Laminate

The cured film of the present invention can be obtained by applying and drying the curable liquid composition, and curing the dried composition by applying radiation.

The surface resistivity of the resulting cured film is 1×10¹² ohm/square or less, preferably 1×10¹⁰ ohm/square or less, and still more preferably 1×10⁸ ohm/square or less. If the surface resistivity exceeds 1×10¹² ohm/square, antistatic properties may be insufficient, whereby dust may easily adhere, or the adhered dust may not be easily removed.

There are no specific limitations to the method of applying the composition. For example, a conventional method such as a roll coating method, spray coating method, flow coating method, dipping method, screen printing method, or ink jet printing method may be used.

There are no specific limitations to the radiation source used to cure the composition insofar as the applied composition can be cured in a short period of time.

As examples of the source of visible rays, sunlight, a lamp, a fluorescent lamp, a laser, and the like can be given. As the source of ultraviolet rays, a mercury lamp, a halide lamp, a laser, and the like can be given. As examples of the source of electron beams, a method of utilizing thermoelectrons produced by a commercially available tungsten filament, a cold cathode method which causes electron beams to be generated by applying a high voltage pulse to a metal, a secondary electron method which utilizes secondary electrons produced by the collision of ionized gaseous molecules and a metal electrode, and the like can be given.

As the source of α-rays, β-rays, and γ-rays, fissionable materials such as ⁶⁰Co can be given. As the source of γ-rays, a vacuum tube which causes accelerated electrons to collide against an anode can be used. The radiation may be applied either individually or in combination of at least two. At least one type of radiation may be applied at specific intervals.

The thickness of the cured film is preferably 0.1-20 μm. In applications such as a touch panel or a CRT in which scratch resistance of the outermost surface is important, the thickness of the cured film is preferably 2-15 μm. In the case of using the cured film as an antistatic film for an optical film, the thickness of the cured film is preferably 0.1-10 μm.

In the case of using the cured film for an optical film, transparency is necessary. Therefore, the total light transmittance of the cured film is preferably 85% or more.

As a substrate to which the cured film of the present invention is applied, a substrate made of a metal, ceramics, glass, plastic, wood, slate, or the like may be used without specific limitations. As a material for making use of high productivity and industrial applicability of radiation curability, it is preferable to apply the cured film to a film-type or fiber-type substrate. A plastic film or a plastic sheet is a particularly preferable material. As examples of plastic, polycarbonate, polymethylmethacrylate, polystyrene/polymethylmethacrylate copolymer, polystyrene, polyester, polyolefin, triacetylcellulose resin, diallylcarbonate of diethylene glycol (CR-39), ABS resin, AS resin, polyamide, epoxy resin, melamine resin, cyclic polyolefin resin (norbornene resin, for example), and the like can be given.

The cured film of the present invention is useful as a hard coat because of its excellent scratch resistance and adhesion. Since the cured film has excellent antistatic properties, the cured film is suitably applied to various substrates such as film-type, sheet-type, or lens-type substrates as an antistatic film.

As application examples of the cured film of the present invention, chief application as a hard coat for preventing scratches on the surface of the product or adhesion of dust due to static electricity, such as a protective film for touch panels, transfer foil, hard coat for optical disks, film for automotive windows, antistatic protective film for lenses, and surface protective film for a well-designed container for cosmetics; application as an antistatic antireflection film for various display panels such as CRTs, liquid crystal display panels, plasma display panels, and electroluminescence display panels; and application as an antistatic antireflection film for plastic lenses, polarization film, and solar battery panel can be given.

In the case of providing an antireflection function to an optical article, it is known in the art that a method of forming a low-refractive-index layer or a multi-layer structure consisting of a low-refractive-index layer and a high-refractive-index layer on a substrate or a substrate provided with a hard coat treatment is effective. The cured film of the present invention is useful as a layer structure which makes up an antistatic laminate for providing an antireflection function to an optical article by forming the cured film on the substrate. Specifically, an antistatic laminate having antireflection properties can be produced by using the cured film of the present invention in combination with a film having a refractive index lower than that of the cured film.

As the antistatic laminate, a laminate including a coat layer having a thickness of 0.05-0.20 mm and a refractive index of 1.30-1.45 as a low-refractive-index layer formed on the cured film of the present invention can be given. As another example of the antistatic laminate, a laminate including a coat layer having a thickness of 0.05-0.20 μm and a refractive index of 1.65-2.20 as a high-refractive-index layer formed on the cured film of the present invention, and a coat layer having a thickness of 0.05-0.20 μm and a refractive index of 1.30-1.45 as a low-refractive-index layer formed on the high-refractive-index layer can be given.

In the production of the antistatic laminate, in order to provide other functions such as a non-glare effect, a selective light-absorption effect, weatherability, durability, or transferability, a layer including light scattering particles with a thickness of 1 μm or more, a layer including dyes, a layer including UV absorbers, an adhesive layer, or an adhesive layer and a delamination layer may be added. Moreover, such a function providing component may be added to the antistatic curable composition of the present invention as one of the components.

The antistatic laminate of the present invention is suitably used as a hard coat material for preventing stains or cracks (scratches) on plastic optical parts, touch panels, film-type liquid crystal elements, plastic casings, plastic containers, or flooring materials, wall materials, and artificial marble used for an architectural interior finish; as an adhesive or a sealing material for various substrates; as a binder for printing ink; or the like.

### EXAMPLES

The present invention is described below in more detail by examples, which should not be construed as limiting the present invention. In the following examples, “part” and “%” respectively refer to “part by weight” and “wt %” unless otherwise indicated.

### Synthesis Example 1

Antimony-containing tin oxide particles (SN-100P, the primary particles size: 10-30 nm, manufactured by Ishihara Techno Co., Ltd.), a dispersant (ADEKA PLURONIC TR-701, manufactured by Asahi Denka Kogyo Co., Ltd.), and methanol were mixed at a ratio of 29.1:0.9:70 (by weight) to obtain a mixture containing 30% of total solid components and 29.1% of total inorganic content.

The mixture was dispersed using an SC mill manufactured by Mitsui Mining Co., Ltd. under the following conditions.

Equipment: SC mill, manufactured by Mitsui Mining Co., Ltd.
Frequency: 60 Hz (equivalent to 3,600 rpm)
Casing capacity: 59 ml

### Amount: 500 g

Amount of dispersion beads: Glass beads (BZ-01, manufactured by TOSHINRIKO), (diameter: 0.1 mm) 40 g, volume filling factor: 27%
The median diameter of antimony-containing tin oxide particles dispersed in the resulting dispersion was measured under the following conditions. The particles were pulverized to a median size of 100 nm in 1-2 hours and were stable with time.
Instrument: Dynamic light scattering particle size distribution analyzer, manufactured by Horiba, Ltd.
Measuring conditions: 25° C.
Sample: Raw dispersion was analyzed as is.
Data analysis Conditions
Particle diameter: Based on volume
Distributed particles: ATO particles, refractive index: 1.95
Dispersion medium: Methanol, refractive index: 1.329

### Example 1

In a UV shielded vessel, 23.3 parts of the dispersion of antimony-doped tin oxide (ATO) prepared in Synthesis Example 1 (dry ATO particles: 6.79 parts, dispersant: 0.21 part, methanol: 16.3 parts), 92 parts of dipentaerythritol pentacrylate (KAYARAD DPHA manufactured by Nippon Kayaku Co., Ltd.), 8.7 parts of methanol, 75.2 parts of methyl isobutyl ketone (the weight ratio of methanol and methyl isobutyl ketone in the composition: 25.0:75.0), 1 part of 1-hydroxycyclohexyl phenyl ketone (Irgacure 184, manufactured by Ciba Specialty Chemicals, Co.) (photoinitiator), and 0.3 part of SURFYNOL DF-58 (manufactured by Nisshin Chemical Industry Co., Ltd.) were mixed by stirring for two hours at room temperature to obtain a composition in the form of a homogeneous solution.

2 g of the composition was weighed on an aluminum dish and dried at 120° C. for one hour on a hot plate. The solid content determined by weighing the dried product was 50 wt %.

### Examples 2-10 and Comparative Examples 14

The compositions of Examples 2-10 and Comparative Examples 1-4 shown in Table 1 were obtained by the same operation as described above. The ratios of the components of the composition other than component (D) are shown in Table 1. The component (D) was added in an amount to make the solid content shown in Table 1. The unit for each component shown in Table 1 is part by weight.

The components shown in Table 1 are as follows. In Table 1, the amount of the component (A) indicates the weight of dry fine powder and dispersant included in each dispersion sol (excluding organic solvent).

### Component (A):

ATO particle dispersion: Synthesis Example 1

### Component (B):

DPHA: dipentaerythritol hexacrylate (KAYARAD DPHA, manufactured by Nippon Kayaku Co., Ltd.):

### Component (C):

SURFYNOL DF-58 (silicone-modified product, manufactured by Nisshin Chemical Industry Co., Ltd.)
ADDID160 (dimethyl siloxane, manufactured by Wacker Chemical Corporation)
ADDID700 (silicone-based product, manufactured by Wacker Chemical Corporation)
ADDID720 (silicone-based product, manufactured by Wacker Chemical Corporation)
ADDID810 (self-emulsified type silicone, manufactured by Wacker Chemical Corporation)

### Surfactant

Disfoam FDS-2224 (polyalkylene glycol ester, manufactured by Nippon Oil and Fats Co., Ltd.)
SURFYNOL DF-37 (acetylene glycol-based product, manufactured by Nisshin Chemical Industry Co., Ltd.)
SURFYNOL 465 (acetylene glycol-based product, manufactured by Nisshin Chemical Industry Co., Ltd.)

### Component (E)

Irgacure 184: (1-hydroxycyclohexyl phenyl ketone, manufactured by Ciba Specialty Chemicals Co., Ltd.)

### Component (D)

### MeOH: Methanol

MIBK: Methyl isobutyl ketone

### Preparation of Cured Film

The compositions obtained in Examples 1-10 and Comparative Examples 1-4 were applied to a polyester film (“A4300” manufactured by Toyobo Co., Ltd., thickness: 188 μm) using a wire bar coater #6, allowed to stand for 30 seconds, and dried at 70° C. for one minute in an oven to form coating films. The films were allowed to stand for 30 seconds and cured by irradiating UV light from a metal halide lamp at a dose of 300 mJ/cm²×3 in air to obtain cured films (hard coating layers) with a thickness of 3 μm.

### Evaluation of Cured Film

Coatability, hase, and surface resistivity of the cured films were evaluated according to the following criteria. The evaluation results are shown in Table 1.

### (1) Coatability

Curable liquid compositions easily coated were rated as “x”, otherwise as “∘”.

### (2) Haze

Haze was determined using a color haze meter (manufactured by Suga Test Instruments Co., Ltd.) on the basis of polyester film A4300 which is a substrate.

### (3) Surface Resistivity

The surface resistivity (ohm/square) of the cured film was measured using a high resistance meter (“Agilent 4339B” manufactured by Agilent Technologies) and a resistivity cell (“16008B” manufactured by Agilent Technologies) at an applied voltage of 100 V.

TABLE 1

| | | Example | | | | | | |
|---|---|---|---|---|---|---|---|---|
| | | 1 | 2 | 3 | 4 | 5 | 6 | 7 |
| Component | Dry weight of ATO | 6.79 | 6.79 | 6.79 | 6.79 | 6.79 | 6.79 | 6.79 |
| (A) | particles | | | | | | | |
| | Weight of dispersant | 0.21 | 0.21 | 0.21 | 0.21 | 0.21 | 0.21 | 0.21 |
| Component | DPHA | 92 | 92 | 92 | 92 | 92 | 92 | 92 |
| (B) | | | | | | | | |
| Component | SURFYNOL DF-58 | 0.3 | | | | | | |
| (C) | ADDID 160 | | 0.3 | | | | | |
| | ADDID 700 | | | 0.3 | | | | |
| | ADDID 720 | | | | 0.3 | 0.005 | 0.10 | 0.20 |
| | ADDID 810 | | | | | | | |
| Surfactant | Disfoam FDS-2224 | | | | | | | |
| | SURFYNOL DF-37 | | | | | | | |
| | SURFYNOL 465 | | | | | | | |
| Component | Irgacure 184 | 1 | 1 | 1 | 1 | 1 | 1 | 1 |
| (E) | | | | | | | | |
| Solid components (%) | | 50 | 50 | 50 | 50 | 50 | 50 | 50 |
| Film thickness (μm) | | 3 | 3 | 3 | 3 | 3 | 3 | 3 |
| Properties | Coatability | ◯ | X | X | ◯ | ◯ | ◯ | ◯ |
| | Haze (%) | 0.8 | 0.9 | 0.9 | 0.8 | 0.6 | 0.7 | 0.6 |
| | Surface resistivity | 7.7 × 10¹¹ | 6.7 × 10¹¹ | 6.9 × 10¹¹ | 8.2 × 10¹¹ | 1.6 × 10¹² | 1.9 × 10¹² | 2.2 × 10¹² |
| | (ohm/square) | | | | | | | |
| | | Example | | | Comparative Example | | | |
| | | 8 | 9 | 10 | 1 | 2 | 3 | 4 |
| Component | Dry weight of ATO | 6.79 | 6.79 | 5.82 | 6.79 | 6.79 | 6.79 | 6.79 |
| (A) | particles | | | | | | | |
| | Weight of dispersant | 0.21 | 0.21 | 0.18 | 0.21 | 0.21 | 0.21 | 0.21 |
| Component | DPHA | 92 | 92 | 93 | 92 | 92 | 92 | 92 |
| (B) | | | | | | | | |
| Component | SURFYNOL DF-58 | | | | | | | |
| (C) | ADDID 160 | | | | | | | |
| | ADDID 700 | | | | | | | |
| | ADDID 720 | 0.50 | | 0.10 | | | | |
| | ADDID 810 | | 0.3 | | | | | |
| Surfactant | Disfoam FDS-2224 | | | | | 0.3 | | |
| | SURFYNOL DF-37 | | | | | | 0.3 | |
| | SURFYNOL 465 | | | | | | | 0.3 |
| Component | Irgacure 184 | 1 | 1 | 1 | 1 | 1 | 1 | 1 |
| (E) | | | | | | | | |
| Solid components (%) | | 50 | 50 | 50 | 50 | 50 | 50 | 50 |
| Film thickness (μm) | | 3 | 3 | 3 | 3 | 3 | 3 | 3 |
| Properties | Coatability | ◯ | X | ◯ | ◯ | ◯ | ◯ | ◯ |
| | Haze (%) | 0.6 | 1.0 | 0.4 | 1.6 | 1.6 | 2.5 | 1.7 |
| | Surface resistivity | 2.5 × 10¹² | 8.1 × 10¹¹ | 3.4 × 10¹¹ | 2.5 × 10¹² | 1.4 × 10¹² | 1.2 × 10¹² | 1.6 × 10¹² |
| | (ohm/square) | | | | | | | |

The values of the component (A) indicate the dry weight of fine particles and dispersant (excluding the weight of solvent) in the charged amount of each dispersed sol.

### INDUSTRIAL APPLICABILITY

The curable liquid composition, cured film, and antistatic laminate of the present invention can be used as a hard coat film, antistatic film, antireflection film for information and telecommunications instruments, optical goods, and the like.

1: A curable liquid composition comprising the following components (A), (B), (C), and (D):
(A) particles comprising at least one oxide of an element selected from the group consisting of indium, antimony, zinc, and tin as a major component,
(B) a compound having two or more polymerizable unsaturated groups in the molecule,
(C) a silicon-containing surfactant, and
(D) a solvent.

2: The curable liquid composition according to claim 1, further comprising (E) a photoinitiator in addition to the components (A) to (D).

3: The curable liquid composition according to claim 1, wherein the component (A) is particles including either antimony-doped tin oxide (ATO) or tin-doped indium oxide (ITO) as a major component.

4: The curable liquid composition according to claim 1, wherein the component (A) is oxide particles surface-treated by using a surface treatment agent.

5: The curable liquid composition according to claim 4, wherein the surface treatment agent is a compound including at least two polymerizable unsaturated groups, a group shown by the following formula (1),
—X—C(═Y)—NH— (1)
wherein X represents NH, O (oxygen atom), or S (sulfur atom), and Y represents O or S, and a silanol group or a group which forms a silanol group by hydrolysis.

6: The curable liquid composition according to claim 5, wherein the group shown by the formula (1) is at least one group selected from the group consisting of —O—C(═O)—NH—, —O—C(═S)—NH—, and —S—C(═O)—NH—.

7: The curable liquid composition according to claim 1, wherein the content of the component (A) in the composition is 10 wt % or less of the total amount of the composition except for the component (D).

8: A cured film obtained by curing the curable liquid composition according to claim 1, the cured film having a surface resistivity of 1×10¹² ohm/square or less.

9: A process for producing a cured film, comprising a step of curing the curable liquid composition according to claim 1 by applying radiation to the composition.

10: An antistatic laminate comprising a layer of a cured film obtained by curing the curable liquid composition according to claim 1.

11: The antistatic laminate according to claim 10, wherein the thickness of the layer of the cured film is 0.1-20 μm.
